(19) United States
(12) Patent Application Publication
(10) Pub. No.: US 2010/0142823 A1
(43) Pub. Date: Jun. 10, 2010

(54) 2D PARTIALLY PARALLEL IMAGING WITH K-SPACE SURROUNDING NEIGHBORS BASED DATA RECONSTRUCTION

(76) Inventors: Ze Wang, Philadelphia, PA (US); John A. Detre, Wynnewood, PA (US)

Correspondence Address: Pearl Cohen Zedek Latzer, LLP, 1500 Broadway, 12th Floor, New York, NY, 10036, US

(21) Appl. No.: 12/522,374

(22) PCT Filed: Mar. 7, 2008
(86) PCT No.: PCT/US08/03029

§ 371 Date: Feb. 16, 2010

Related U.S. Application Data
(60) Provisional application No. 60/905,302, filed on Mar. 7, 2007.

(51) Int. Cl. G06K 9/40; G06K 9/46

(52) U.S. Cl. 382/195; 382/275

(57) ABSTRACT

Embodiments of the present invention relate to a Surrounding Neighbors based Autocalibrating Partial Parallel Imaging (SNAPPI) approach to MRI reconstruction. Several 2D PPI reconstruction methods may be provided by applying SNAPPI to recover the partially skipped k-space data along two PE directions separately or non-separately, in k-space or in the hybrid k-space and image-space.

### GOVERNMENT INTEREST

This invention was made with Government support under Grants No. DA015149 and RR02305, awarded by the National Institutes of Health. The Government may have certain rights in the invention.

### BACKGROUND OF THE INVENTION

1. Field of the Invention

The present invention relates to Magnetic Resonance Imaging (MRI). More specifically, the present invention relates to a method of reconstructing k-space data points that are not acquired during Partially Parallel Imaging (PPI) by using additionally acquired k-space reference data points.

2. Description of the Related Art

Magnetic Resonance Imaging (MRI) is an imaging technique typically used in medicine to generate images of the human body. MRI scanners are particularly effective in imaging soft tissues whereas x-rays and CT (Computed Tomography) scanners are typically better at imaging dense tissues. MRI scanners do not use the harmful ionizing radiation which is used in x-rays and CT scanners. Instead, MRI scanners use magnets and radio frequency signals.

MRI technology is based on the fact that nuclei with an odd number of protons or neutrons will exhibit a net angular momentum. This angular momentum is a quantum mechanical property inherent to the particle and is not the same as the angular momentum of a body rotating about its axis, such as the rotation of the Earth about its axis, or of a body rotating about another object, such as the orbit of the Earth around the sun. This angular momentum is known as “spin”. A particle with a net spin will exhibit a magnetic dipole moment. This means that particles with a net spin will be affected by a magnetic field much in the same way that charged particles are affected by an electric field. In particular, particles with a net spin will align the direction of their spin with the magnetic field and begin to precess about this axis. Thus, if the magnetic field is applied in the positive z axis, the spin direction will also be along the z axis and precession will occur about the z axis in the xy plane.

The simplest particle which is found in abundance in the human body and which has a net spin is the hydrogen atom. A hydrogen atom has a nucleus which is a single proton. Since a proton has a spin of ½, the hydrogen nucleus has a spin of ½. In classical mechanics, angular momentum is a vector quantity meaning it has both a magnitude and a direction. Although technically, spin is more than just a vector quantity (in fact, it is a spinor quantity), for the sake of simplicity, since a spinor has directionality just as a vector does, the term spin vector will be used instead of spin spinor. The magnitude of spin for a hydrogen nucleus is ½. The directionality of spin for a particle with spin ½ can occur in two different directions which are commonly known as spin-up and spin-down.

When hydrogen atoms are placed in a magnetic field, their spin vectors align with the magnetic field in either a parallel or anti-parallel manner, i.e. the spin vector is in the same direction as the magnetic field (along the positive z axis) or in the opposite direction of the magnetic field (along the negative z axis). The hydrogen atoms will also precess about their alignment axes in the xy plane at a well defined frequency. This frequency (ω₀) is known as the Larmor frequency and is described by:

ω₀=γB₀, where γ is the gyromagnetic ratio and B₀ is the applied magnetic field.

At room temperature, hydrogen atoms that are in a parallel alignment (i.e., the spin vector is in the same direction as the magnetic field) are in a lower energy state than the hydrogen atoms that are in an anti-parallel alignment. Thus, a greater number of hydrogen atoms will have their spin vector aligned with the magnetic field than aligned 180 degrees opposite the magnetic field. Although the excess number of parallel aligned atoms over anti-parallel aligned atoms is only about 3 to 4 parts per million, it is enough to create an overall magnetic dipole moment which results in a net magnetization vector in the same direction as the magnetic field.

The hydrogen atom can transition between the lower energy state (parallel alignment) and the higher energy state (anti-parallel alignment) if it absorbs energy equal to the difference in energy between the two energy states. This energy can be imparted to the hydrogen atom by means of a photon. The energy (E) of a photon is related to its frequency (v) by the following equation:

E=hv, where h is Planck's constant, 6.626*10̂−34 J s

The energy of the photon needed to transition a parallel aligned hydrogen atom to an anti-parallel aligned hydrogen atom has a frequency (v) exactly equal to the Larmor frequency above. Thus, the energy of the photon necessary to cause a state transition has a frequency equal to the frequency at which the atom precesses about the axis of the magnetic field. If a radio frequency (RF) pulse perpendicular to the magnetic field (i.e., in the x or y direction) is applied to the atoms at a frequency equal to the Larmor frequency, some of the hydrogen atoms in the lower energy state will be excited, and “flip” to an anti-parallel alignment. The net magnetization vector will begin to move from the z axis into the perpendicular xy plane. The magnetization vector moves to the xy plane because it is affected by the RF pulse which is essentially a second magnetic field. By adjusting the energy of this RF pulse, enough parallel aligned hydrogen atoms can be flipped to anti-parallel alignment such that the number of parallel and anti-parallel aligned atoms is approximately equal. Thus, the net magnetization vector is zero along the axis of the magnetic field (the z axis). By adjusting the time of this pulse, the net magnetization will move completely to the xy plane (i.e., the vector will be completely perpendicular to the z axis). Even though the net magnetization is now in the xy plane, the spin vectors will still precess around the z axis at the Larmor frequency. Such a pulse is known as a 90 degree RF pulse.

Once the RF pulse ends, the hydrogen atoms begin to return to their pre-excited state. The hydrogen atoms that absorbed RF energy and flipped from a parallel alignment to an anti-parallel alignment will now release this energy and return to their original parallel alignment. The return to equilibrium is known as “relaxation”. Relaxation does not occur immediately; instead, it occurs over a period of time. Two time constants define the hydrogen atoms' return to equilibrium. The first time constant (T1), which is longer, is referred to as the spin-lattice relaxation time, and corresponds to the time required for the net magnetization vector to regain 63% of its original value along the z axis (the same direction as the applied magnetic field). The second time constant (T2), which is shorter, is referred to as the spin-spin relaxation time, and corresponds to the time required for the net magnetization vector to retain only 37% of its value in the xy plane (perpendicular to the applied magnetic field).

Different tissues in the body have different time constant values given the same applied magnetic field and ambient temperature. For example, when the magnetic field strength is 1.5 Tesla and the environment temperature is 37° C., muscle tissue has a T1 constant of 900 ms and a T2 constant of 50 ms whereas blood has a T1 constant of 1200 ms and a T2 constant of 100-200 ms. The energy that is released as the hydrogen atoms return to equilibrium will be at the Larmor frequency and proportional to the number of hydrogen atoms. This energy is picked up by receiver coils within the MRI scanner. The amount of energy and the time over which it arrives at the receiver coils is recorded and used to produce the MRI image. For example, the amount of energy may be used to indicate a lighter or darker section of the image. Similarly, the length of time over which energy arrives can be used to differentiate tissue types by using different contrast levels.

However, because the same magnetic field is applied to the entire body, every hydrogen atom will release energy at the same frequency, the Larmor frequency as determined by that field. This makes it impossible to tell the spatial origin of the received signal within the body. In order to distinguish one area of the body from another, an encoding scheme must be used to spatially encode the energy received during the relaxation time. In order to spatially encode the received information in all three spatial directions, magnetic field gradients are introduced to the applied magnetic field along the three spatial axes. The gradient is a linearly varying magnetic field which is added to the applied magnetic field and in so doing, also varies the Larmor frequency (ω) to the following:

ω=γ(B₀+G·r) where γ is the gyromagnetic ratio, B₀ is the applied magnetic field, G is the three dimensional gradient and r denotes the spin position.

In order to encode information in three spatial directions, magnetic field gradients must be applied to change the base magnetic field in three dimensions. These gradients are not applied at the same time. Rather, a sequence of gradients along the three spatial axes is used to produce three dimensional changes to the Larmor frequency such that each three dimensional subsection of space (voxel) has a different Larmor frequency and phase associated with it. Because each voxel has a different Larmor frequency and phase associated with it, it is possible to locate that voxel spatially by using a lookup table for spatial location versus Larmor frequency and phase.

To spatially divide a body into subsections, the body is first divided into slices of a certain thickness. Each slice is then divided into rows of a certain height and finally each row is subdivided into voxels of a certain width. It is desirable that every slice has the same thickness, every row has the same height and every voxel has the same width such that every subsection has the same size and volume. One method of spatially encoding the body is now described:

Defining the axis that extends from a person's head to his or her feet as the z axis, a slice can be defined as being in the xy plane, perpendicular to the z axis, but having a certain thickness in the z axis. While it is possible to take slices in other directions or along other angles, the xy plane slice is the simplest conceptually. A first linear magnetic gradient is applied along the z axis which affects the base magnetic field strength. If the base magnetic field is 1.5 T, an illustrative example of such a gradient would result in a magnetic field which has an intensity of 1.4 T at the top of the head and increases linearly along the z axis to 1.6 T at the bottom of the feet. The affect of such a gradient field is that every slice of the body is affected by a different magnetic field intensity. Thus, every slice can be associated with a different Larmor frequency range. The thickness of the slice is related to the range of magnetic field intensities, the steepness of the gradient, and the desired number of slices. For illustrative purposes, if the magnetic field has a range of 1.4 T to 1.6 T it may be decided that 20 slices will be used with each slice being 0.01 T thick. In this case, the first slice from 1.4 T to 1.41 T would have Larmor frequencies from γ*1.4 T to γ*1.41 T. An individual slice can then be selected by using a 90 degree RF pulse that contains only the frequencies in a particular slice. The RF pulse will affect only this particular slice by causing the net magnetization vector within this slice to rotate 90 degrees from the z axis to the xy plane and precess about the z axis at the Larmor frequency. Once this is accomplished, the RF pulse and z axis gradient are shut off.

During the relaxation time, other gradients may be applied to spatially differentiate rows and voxels within the slice. A second linear magnetic gradient can be applied along the y axis. Because this gradient is in the y axis, it will affect hydrogen atoms within the selected slice since their net magnetization vector is now in the xy plane. Similar to the gradient that was applied in the z axis, the y axis gradient will cause a linearly increasing magnetic field in the y axis and thus a linearly increasing Larmor frequency in the y axis. Hydrogen atoms within the slice will now begin to precess at a linearly increasing rate along the y axis. The y axis gradient is then shut off. The hydrogen atoms will now begin to precess at their original Larmor frequency. However, the original precession about the z axis will renew at the angular position the atoms had when the y axis gradient field was shut off. Because the precession occurred at different rates along the y axis, the precession will renew at the original Larmor frequency at different angular positions. For illustrative purposes, once the y axis gradient is applied one hydrogen atom may be precessing at 1 Hz while another may be precessing at 1.5 Hz. Since both atoms are part of the same slice they began precessing at their new rates at the same time, at an angular position of 0 degrees. If the y axis gradient is applied for 1 second, the first hydrogen atom will renew its original precession rate at 0 degrees while the second will renew its original precession rate at 180 degrees. As can be seen from this illustrative example, the end result of the y axis gradient is that the hydrogen atoms within the slice now precess at different phases. Applying a linear gradient along the y axis is therefore called phase encoding. The phase difference increases linearly along the y axis and can be used to identify rows within the slice. As with slice selection, the height of the row will depend on the range of magnetic field intensities, the steepness of the gradient, and the desired number of rows.

A third linear magnetic gradient can be applied along the x axis, which is generally called frequency encoding. This causes the hydrogen atoms within the slice to precess at different Larmor frequencies. The frequency difference increases linearly along the x axis and can be used to identify voxels within each row. As with slice selection, the width of the voxel will depend on the range of magnetic field intensities, the steepness of the gradient, and the desired number of voxels. There is now enough information to spatially locate any subsection. Any subsection belongs to a given slice and within that slice belongs to a row of a certain phase and within that row belongs to a voxel of a certain frequency. As the hydrogen atoms return to their initial energy state, energy is released. The frequency and phase of this energy is used to spatially determine what subsection produced the energy. The amount of energy received from this subsection is an indication of the density of hydrogen atoms in this region and will thus affect the contrast within this subsection of a resulting image.

Thus, a three dimensional subsection of a body may be addressed by the application of gradient magnetic fields and a 90 degree RF pulse. It is clear then that 2D MRI scanning progresses by selecting the first slice, then within that slice scanning the first row. All voxels within that row are progressively scanned. Every subsequent row within the slice is scanned in such a manner. Once all rows are scanned within the slice, scanning proceeds to the next slice until all slices are scanned.

An image of a particular slice is created from the received signal s(kₓ,k_{y}) using a 2D Fourier transform:

$$s ( {k}_{x} , {k}_{y} ) = \int \int ρ ( x , y ) {e}^{- i2π ( {k}_{x} x + {k}_{y} y )} d x d y , \\ where : \\ {k}_{x} = \frac{γ}{2 π} {\int }_{0}^{t} {G}_{x} ( τ ) d τ , \\ {k}_{y} = \frac{γ}{2 π} {\int }_{0}^{t} {G}_{y} ( τ ) d τ and$$

ρ(x, y) is the spin density. The spin density is the density of hydrogen atoms within a subsection and thus is essentially the “image” of the slice. The spin density is obtained from the received signal by taking the inverse Fourier transform of the above equation. Because ρ(x, y) represents the image, it is usually referred to as “image-space” whereas s(kₓ,k_{y}) is usually referred to as “k-space”, and (kₓ,k_{y}) are the corresponding k-space coordinates with the unit vector defined by the frequency encoding gradient Gₓ and the phase encoding gradient G_{y}, respectively.

Quite similar manipulations are used in 3D MRI. Instead of flipping each slice with an RF pulse independently, a big slab containing all slices to be scanned is flipped in 3D MRI. Signal acquisition is accomplished by using two phase encoding gradients (one along z-axis, and the other along y-axis) and a frequency encoding gradient. In other words, three gradients will be applied to partition the 3D k-space in 3D MRI. The received k-space data can be then represented by s(kₓ,k_{y},k_{z}), where

$${k}_{z} = \frac{γ}{2 π} {\int }_{0}^{t} {G}_{z} ( τ ) d τ$$

and G_{z} is the second phase encoding gradient applied along z-axis. The 3D image volume will be finally generated using a 3D Fourier transform.

Because all voxels must be scanned sequentially, scanning time for an MRI device may take an inordinate amount of time. Early MRI scanners had scan times on the order of many minutes or even an hour. It is clearly desirable to shorten the scan time. Not only does this increase patient comfort and result in clearer images (due to less voluntary and involuntary movement of scanned body parts) there are also economic benefits since MRI machines are very expensive and the ability to scan more patients in a given amount of time would result in faster return on investment for the device. Unfortunately, a hard limit on scanning speed using the method described above is imposed by an inability to apply very quickly changing gradient fields due to technological constraints and physiological constraints (quickly changing gradient fields can result in painful peripheral nerve stimulation).

Various techniques have been developed to reduce scan times in MRI by essentially reducing the number of voxels to be scanned instead of scanning every single one. Since the scan time for a single row after applying a phase encoding step could be quite short, it is usually more desirable to reduce the number of rows instead of the number of voxels within each row. For example, every other row might be scanned. The effect of reducing the number of rows to be scanned is a reduced field of view (FOV) compared to scanning every single subsection which is known as a full FOV. The number of skipped rows is known as a reduction factor (RF) or acceleration factor (AF). If every other row is scanned in a particular direction, this would be known as a acceleration factor of 2. Since there are two phase encoding directions (i.e., the phase encoding in the z direction and phase encoding in the y direction) in 3D MR imaging, it is possible to have a reduction factor in each direction. The total overall reduction factor is then said to be the product of the two reduction factors. For 2D MR imaging, it is still possible to have a reduction factor along both the phase encoding direction y and the frequency encoding direction x, though acceleration in the frequency encoding direction is generally less demanded than in the phase encoding direction.

When such a technique is used, the missing data must be filled in or an aliased image will result. The missing data are filled in by using additional receiving coils. The principle behind using additional coils is that the reduction of spatial encoding through applying linear magnetic gradients can be compensated by the spatially localized coil sensitivity encoding of each component coil. Using two or more receiving coils, the signal from the same voxel will be received in each coil at the same time but with different sensitivity modulation. This spatially variable sensitivity modulation can be utilized to synthesize the skipped phase encoding steps, and therefore can be used to fill in the missing data. Two methodologies have been employed to fill in the data missing from the skipped voxels by using the multiple received signals from the scanned voxels. These methodologies are known as partially parallel acquisition or partially parallel imaging (PPI).

The first methodology attempts to fill in the missing data in “image-space”. In other words, an inverse Fourier transform is performed on the signal received from each coil. Because the signal is missing data, a different aliased (folded over) image is obtained from each coil. The degree of aliasing will depend on how much data is skipped. A correct full FOV image is created from the aliased images by “unfolding” all component coils' aliased images by using a coil sensitivity matrix which contains information on how each pixel in each coil's aliased image is related to each pixel in the correct full FOV image. SENSE is one such technique which makes use of this method. The ability to “unfold” the aliased images is solely dependent upon the sensitivity matrix. Because this sensitivity matrix is difficult to obtain accurately, especially in areas with poor signal quality, SENSE reconstructions may be inaccurate.

The second methodology attempts to fill in the missing data in “k-space”. In other words, an attempt is made to fill in the missing data before the k-space data is turned into an image via the Fourier transform. These methods generally acquire additional k-space data and attempt to discover a relationship between the signals received on each coil from the acquired data and the additionally acquired data. This relationship is then extrapolated from the acquired data to the missing data. Once the missing data is filled in, the inverse Fourier transform is performed to obtain an image. Generalized Auto-calibrating Partially Parallel Acquisitions (GRAPPA) is one technique which makes use of this method. Assuming AF is applied along the y-axis, GRAPPA only uses the sensitivity encoding information from the acquired data points within the same columns (x-axis) as the missing data points. As a result, the GRAPPA reconstructed images still suffer from aliasing artifacts due to incomplete missing data reconstruction, especially in the case of high AF PPI. Moreover, for 2D PPI, GRAPPA uses previously recovered data in subsequent recovery steps; thus, errors can multiply rapidly with each iterative step.

Thus, there is a need for a new technique which increases the speed of data acquisition, is more accurate, has a higher Signal to Noise Ration (SNR), and can work with three dimensional MRI scanners.

### SUMMARY OF THE INVENTION

In an embodiment of the present invention, a method may include identifying a missing data point from one receiver coil of a plurality of receiver coils, wherein the missing data point is not acquired due to partially parallel imaging. The method may further include forming an interpolation net having weights including at least the missing data point and acquired data points from the plurality of receiver coils, wherein the acquired data points surround the missing data point. The method may further include estimating the weights of the interpolation net using additionally acquired data points surrounding the missing data point. The method may further include reconstructing the missing data point using the weights of the interpolation net.

In an embodiment of the present invention, a device may include a processor for identifying a missing data point from one receiver coil of a plurality of receiver coils, wherein the missing data point is not acquired due to partially parallel imaging. The device may further include the processor for forming an interpolation net having weights including at least the missing data point and acquired data points from the plurality of receiver coils, wherein the acquired data points surround the missing data point. The device may further include the processor for estimating the weights of the interpolation net using additionally acquired data points surrounding the missing data point. The device may further include the processor for reconstructing the missing data point using the weights of the interpolation net.

In an embodiment of the present invention, a processor-readable storage medium may have stored thereon instructions that when executed by a processor result in at least identifying a missing data point from one receiver coil of a plurality of receiver coils, wherein the missing data point is not acquired due to partially parallel imaging. The instructions may further result in forming an interpolation net having weights including at least the missing data point and acquired data points from the plurality of receiver coils, wherein the acquired data points surround the missing data point. The instructions may further result in estimating the weights of the interpolation net using additionally acquired data points surrounding the missing data point. The instructions may further result in reconstructing the missing data point using the weights of the interpolation net.

### DESCRIPTION OF THE DRAWINGS

Embodiments of the present invention will be understood and appreciated more fully from the following detailed description in conjunction with the figures, which are not to scale, in which like reference numerals indicate corresponding, analogous or similar elements, and in which:

FIG. 1 shows a Surrounding Neighbors based Auto-calibrating Partially Parallel Imaging (SNAPPI) technique in three dimensional k-space for a two dimensional Partially Parallel Imaging (PPI) with a reduction factor of 2 along each phase encoding direction according to an embodiment of the present invention;

FIG. 2A shows a planar view of two dimensional (2D) SNAPPI reconstruction with AF of 2 along each phase encoding direction using a regular 2D PPI Cartesian sampling paradigm according to an embodiment of the present invention;

FIG. 2B shows a planar view of 2D SNAPPI reconstruction with AF of 2 along each phase encoding direction using a Controlled Aliasing In Parallel Imaging Results IN Higher Acceleration (CAIPIRINHA) sampling paradigm according to an embodiment of the present invention;

FIG. 3 shows a histogram of the RRMS performance of different SNAPPI reconstructions in the 2D PPI simulations using 5 subjects' sagittal full-FOV scan with PE along y and x according to embodiments of the present invention;

FIG. 4 shows a flowchart of a method useful for reconstructing missing data points according to an embodiment of the present invention;

FIG. 5 shows an axial slice of a reference image and the simulated 1D and 2D PPI images reconstructed by various SNAPPI reconstruction strategies using a representative subject's 3D fully sampled sagittal MRI data according to embodiments of the present invention;

FIG. 6 shows a reference image and the simulated two dimensional PPI images using the full FOV three dimensional axial acquired MRI volume data with phase encoding along y and z according to an embodiment of the present invention; and

FIG. 7 shows three slices from the sagittal, coronal, and axial views of in-vivo two dimensional PPI images according to an embodiment of the present invention.

### DESCRIPTION OF THE PREFERRED EMBODIMENT

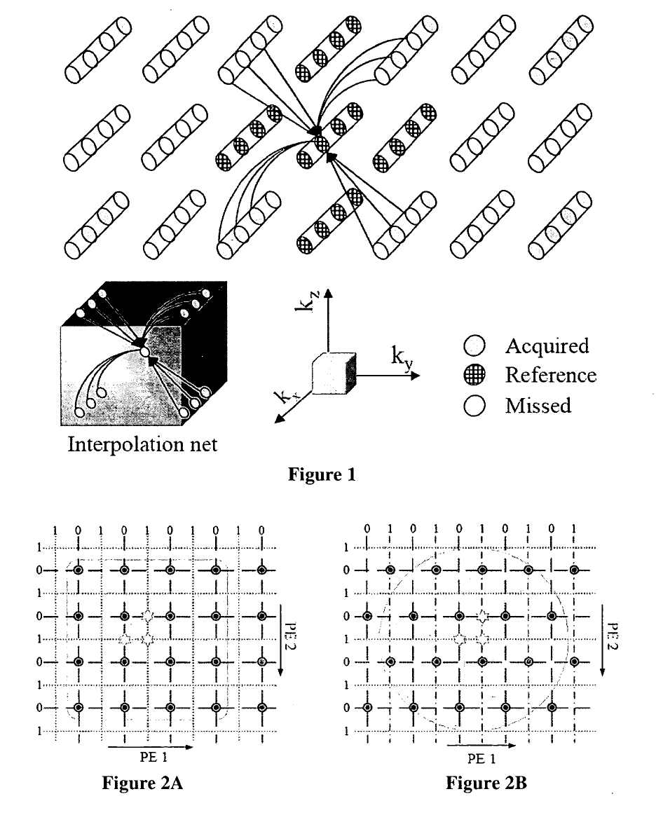

Multi-Column Multi-Line Interpolation (MCMLI) was previously proposed to improve the GRAPPA reconstruction by including all surrounding acquired neighbors within a cubic neighborhood to reconstruct a missing k-space data point. This was originally applied to one dimensional (1D) PPI in Fourier MRI. This concept may be generalized to embodiments of the present invention known as Surrounding Neighbors based Auto-calibrating Partially Parallel Imaging (SNAPPI). FIG. 1 shows a SNAPPI technique in three dimensional k-space for a two dimensional PPI with a reduction factor of 2 along each phase encoding direction according to an embodiment of the present invention. The two Phase Encoding (PE) directions and readout may be denoted as k_{z}, k_{y}, and kₓ, respectively. In embodiments of the present invention, to recover a missing k-space data point of a component coil, SNAPPI may form an interpolation net first, consisting of a missing data point and its surrounding neighboring points from all component coils along the kₓ, k_{y}, and k_{z} directions as in MCMLI. Such an embodiment may then be treated as a special case of SNAPPI in 1D PPI. Each circle in FIG. 1 may represent data points from all component coils with the same k-space coordinate, though the root node of the interpolation net may correspond to a missing data point from one specific component coil. The interpolation net weights (or SNAPPI reconstruction parameters) may then be estimated using the additionally acquired reference data as marked by crosshair filled circles in FIG. 1. In FIG. 1, the kernel size of the interpolation net is k_{z}×k_{y}×kₓ=2×2×3.

As an intrinsic process of modulating spatially localized sensitivity waveforms to synthesize R−1 (R≧1 is the AF along a certain PE direction) adjacent spatial harmonics corresponding to those skipped phase encoding steps, in embodiments of the present invention SNAPPI may only have R−1 independent sets of reconstruction parameters to be estimated for each coil, each corresponding to a relative offset in the PE direction. For an easy description, this feature can be described by a label system. FIG. 2A shows a planar view of two dimensional (2D) SNAPPI reconstruction with AF of 2 along each phase encoding direction using a regular 2D PPI Cartesian sampling paradigm according to an embodiment of the present invention. FIG. 2B shows a planar view of 2D SNAPPI reconstruction with AF of 2 along each phase encoding direction using a Controlled Aliasing In Parallel Imaging Results IN Higher Acceleration (CAIPIRINHA) sampling paradigm according to an embodiment of the present invention. A number from 0 to R−1 is used to denote the data status along each PE direction with 0 meaning acquired, and m (1≦m≦R−1) meaning skipped PE steps with an offset of mΔk (Δk is the k-space sampling interval) to their preceding acquired lines marked with 0. For the embodiments shown in FIGS. 2A and 2B, there are only two independent labels for each PE direction, PE1 and PE2. The dashed lines marked by 0 represent acquired PE steps with the acquired data points marked by solid circles; the dotted lines marked by 1 mean skipped PE steps. Using the label system, it is easy to notice that there are only 3 possible coordinates of the missing data in FIGS. 2A and 2B: (0,1), (1,1), and (1,0) as marked by the three stars. The missing data of each component coil with the same coordinates can be recovered using the same interpolation net. For simplicity, the same neighbors can be used to form the interpolation net for each of these missing points, as highlighted by the large gray square in FIG. 2A and the large gray circle in FIG. 2B, which represents the acquired neighbor searching region which can be of arbitrary shape.

Denoting the signal value as S, and the sampling intervals along kₓ, k_{y} and k_{z} coordinates as Δkₓ, Δk_{y} and Δk_{z}, respectively, in embodiments of the present invention the 2D SNAPPI data reconstruction process may be described by:

$${S}_{j} ( {k}_{x} , {k}_{y} + {r}_{y} Δ {k}_{y} , {k}_{z} + {r}_{z} Δ {k}_{z} ) = {\sum }_{l = 1}^{L} {\sum }_{( b , h , q ) ∈ Ω} AB \\ where : \\ A = {W}_{j , l , {r}_{y} , {r}_{z}} ( b , h , q ) , \\ B = {S}_{l} ( {k}_{x} + h Δ {k}_{x} , {k}_{y} + {bR}_{y} Δ {k}_{y} , {k}_{z} + {qR}_{z} Δ {k}_{z} ) , \qquad ( Eq . 1 )$$

L is the number of component coils used, and j represents the j-th coil.
R_{y}(R_{y}≧1) and R_{z}(R_{z}≧1) refer to the AF along k_{y} and k_{z}, respectively.
r_{y}(1≦r_{y}<R_{y}) and r_{z}(1≦r_{z}<R_{z}) are the relative offsets along k_{y} and k_{z}, respectively.
Ω indicates the index set of the acquired surrounding neighbors of location (kₓ, k_{y}+r_{y}Δk_{y}, k_{z}+r_{z}Δk_{z}).
W_{j,l,r}_{_{y}}_{,r}_{_{z}} refers to the interpolation net weights from the l-th component coil for the target missing data points with label (r_{y}, r_{z}) in the j-th coil.

In embodiments of the present invention, using additionally acquired reference data with full sampling density in the central k_{z}-k_{y} plane, the interpolation weights may be estimated by solving the inverse problem of Eq. 1. The floating interpolation net based fitting concept may be used to increase the number of training sets by shifting the interpolation net (represented by the star and the small solid circles within the gray area in FIGS. 2A and 2B) to all possible positions in the reference data matrix space. Embodiments of the present invention apply equally to the Cartesian sampling based Fourier imaging and to other k-space sampling strategies if the sampling patterns of the calibration scan and the PPI scan have the same k-space topology, i.e., the distance between two neighboring points along a certain direction is the same in both calibration data and PPI data. An example of non-Cartesian sampling is the equivalent distance radial sampling as implemented in radial GRAPPA. Other non-Cartesian sampling such as spiral trajectories could also be applied to embodiments of the present invention using interpolation based approaches such as regridding.

### 2D Separable SNAPPI Reconstruction

In embodiments of the present invention, the separately applied PE along each direction in three dimensional (3D) Fourier MR imaging may render an alternative 2D SNAPPI reconstruction by applying 1D SNAPPI reconstruction along each PE direction separately. The reconstruction coefficients of each PPI reconstruction step may be estimated independently using the reference data. Part of the reconstructed k-space data may be used for other missing data reconstruction in the second SNAPPI reconstruction step, as can be seen from the sampling paradigm in FIG. 2A.

### 2D SNAPPI Reconstruction in the Hybrid Space

In embodiments of the present invention, limited to the PE directions, which are independent of the readout direction kₓ, 2D PPI reconstruction may be applied either in the 3D k-space before any inverse Fourier transform or may be applied in the hybrid space (k-space and image-space) after inverse Fourier transform along the readout. Compared to the 3D k-space reconstruction approach, the hybrid space approach may need more data fitting datasets to estimate SNAPPI parameters for each k_{z}-k_{y} plane along the readout direction.

2D SNAPPI with an Optimal Sampling Pattern

Controlled Aliasing In Parallel Imaging Results IN Higher Acceleration (CAIPIRINHA) was originally proposed to control the 2D SENSE reconstruction aliasing in a PE direction which does not have enough sensitivity variation for applying PPI. In embodiments of the present invention, this optimal sampling strategy may also be used in 2D SNAPPI. As shown in FIG. 2B, the sampling points along PE1 are shifted with an additional offset every second phase encoding step in PE2. Using the same label system as the regular 2D PPI sampling paradigm shown in FIG. 2A, each missing data point can be assigned to one of the several independent data states. It should be noted that different neighbors can be used to reconstruct one of the three data points, and the neighbor searching region can also be of any arbitrary shape rather than the circle (or cylinder) shown in FIG. 2B.

Exploring k-space PPI reconstruction, in embodiments of the present invention SNAPPI may be a generalization of a previously reported method, MCMLI, which has demonstrated superiority to the original GRAPPA reconstruction by including more surrounding neighbors to recover the missing data. Various 2D PPI reconstruction strategies may use separable or non-separable SNAPPI in either 3D k-space or the hybrid space. In embodiments of the present invention, separable SNAPPI may be similar to the 2D GRAPPA-operator for 3D MRI, while non-separable SNAPPI may be similar to the GRAPPA reconstruction approach. Simulations and in-vivo imaging experiments presented below demonstrate that in certain embodiments of the present invention non-separable SNAPPI outperformed separable SNAPPI. Since separable SNAPPI uses previously reconstructed missing data in the second data reconstruction step along another PPI direction, additional reconstruction errors may be introduced due to the imperfect reconstructions in the first PPI reconstruction step. For non-separable SNAPPI, data reconstruction for each missing data point is based on acquired data, so there may be no such issue of reentry of reconstruction errors. Also, with the same amount of calibration data the non-separable SNAPPI may get more fitting data sets than separable SNAPPI using the floating net based fitting approach.

In embodiments of the present invention, operating non-separable SNAPPI in the hybrid space may yield a little better PPI reconstruction quality than operating in the 3D k-space. By running non-separable SNAPPI in the 3D k-space (2DPPI-nonSep-k), it was assumed that the reconstruction coefficients for each readout were the same. When this ideal assumption is violated somehow in real PPI imaging, non-separable SNAPPI in 3D k-space may introduce a more complex noise pattern than non-separable SNAPPI in the hybrid space, which applies SNAPPI fitting and reconstruction for each k_{z}-k_{y} plane so that the residual noise is confined to each image plane. However, no significant reconstruction quality difference was found in the simulations of non-separable SNAPPI in the hybrid space and in the 3D k-space even when an optimal sampling paradigm was used. This may be due to the amount of reference data used in the simulations. With the same amount of autocalibration data, SNAPPI in 3D k-space may have inherently much more reference data than SNAPPI in the hybrid space, resulting in an improved reconstruction coefficient estimation, which may compensate the performance difference between SNAPPI in 3D k-space and SNAPPI in the hybrid space. Increasing the autocalibration data should manifest the performance difference but will also decrease the net AF. Different amounts of autocalibration data have been used for SNAPPI in 3D k-space and in the hybrid space to partly compensate the difference of real reference data amounts between SNAPPI in 3D k-space and SNAPPI in the hybrid space. Since the reconstruction coefficients may need to be estimated separately for each x plane in SNAPPI in the hybrid space, the total reconstruction coefficient estimation time is roughly max(x)=H times that of SNAPPI in the 3D k-space, where max(x) is the image dimension along x and H is the number of neighboring points used along kₓ. Considering the reconstruction quality, the reconstruction coefficient estimation time and the amount of calibration data, in an embodiment of the present invention non-separable SNAPPI in 3D k-space (2DPPI-nonSep-k or CAIPIRINHA-k) may be the best choice among all 2D SNAPPI variations presented. In an embodiment of the of the present invention, the in-vivo imaging experiment below demonstrated a successful 2D PPI with a net AF of 6 by applying PPI along y and x directions.

When one PPI direction does not have enough receiver coil sensitivity variation for an effective PPI reconstruction, the CAIPIRINHA sampling scheme may be used to control the aliasing along that direction by shifting an additional sampling step of every second PE step along the other PE direction. In certain embodiments of the present invention, simulations on PPI along y and x and especially on PPI along z and y showed better reconstruction quality by using CAIPIRINHA sampling scheme rather than the regular Cartesian sampling paradigm.

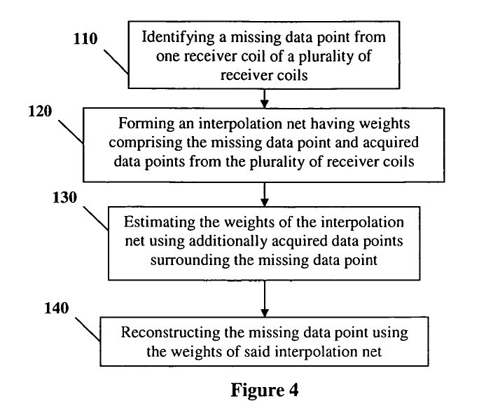

FIG. 4 shows a flowchart of a method useful for reconstructing missing data points according to an embodiment of the present invention. The method may begin with step 110 in which a missing data point from one receiver coil of a plurality of receiver coils may be identified. The missing data point may not have been acquired due to a partially parallel imaging scanning technique. The method may continue to step 120 in which an interpolation net having weights comprising the missing data point and acquired data points from the plurality of receiver coils may be formed. The acquired data points may surround the missing data point. The method may continue to step 130 in which the weights of the interpolation net may be estimated using additionally acquired data points that surround the missing data point. The method may continue to step 140 in which the missing data point may be reconstructed using the weights of the interpolation net.

In embodiments of the present invention, the method shown in FIG. 4 may be capable of being executed by a processor, a controller, a computer, or any comparable device. In embodiments of the present invention, the method shown in FIG. 4 may be stored as instructions on a processor-readable storage medium and be capable of being executed by a processor, a controller, a computer, or any comparable device.

In yet other embodiments, the methods described hereinabove are used in sequential imaging such as cine imaging in one embodiment, or fMRI in another embodiment. In one embodiment, the term “cine imaging” refers to a technique in which, a sequence of individual phase images care acquired at particular time intervals, so that afterwards a time-resolved overview of one or more individual tissue/organ phases is provided, which can be viewed as a video sequence if necessary.

### EXAMPLES

### Data Acquisition

3D Cartesian Fourier MRI acquisitions with and without 2D PPI were performed according to an embodiment of the present invention with one subject following written consent on a Siemens Trio 3T whole body MR scanner with a product 8-channel array coil (Siemens, Erlangen, Germany). The two directions which have enough sensitivity variation for applying PPI with this array coil are the anterior-posterior (y) and left-right (x) directions of a subject lying supine in the scanner.

Four scans with a 3D MPRAGE sequence were performed:
1) Sagittal full-FOV scan with PE along y and x, TR/TE/TI=1620/3.88/950 ms, matrix readout×PE1 ×PE2=128×128×60, FOV=250×250×180, flip angle=15°;
2) Axial full-FOV scan with PE along z (the inferior-superior direction, also the B₀ field direction) and y, TR/TE/TI=1620/3.87/950 ms, matrix=128×128×96, FOV=250×250×160, flip angle=15°;
3) In-vivo 2D PPI sagittal scan using the regular 3D Cartesian sampling paradigm (FIG. 2A) with PE along y with an AF of 3 and x with an AF of 2; and
4) Reference Full-FOV scan for the in-vivo 2D PPI data reconstruction with TR/TE/TI=1620/3.43/950 ms, matrix=128×128×88, FOV=250×250×198, flip angle=15°).

### Simulations

Simulations were performed by sub-sampling (under-sampling) the sagittal and axial full-FOV 3D MRI volumes with the sampling paradigm as shown in FIGS. 2A and 2B using an AF of 2 along each PE direction according to embodiments of the present invention. 1D PPI was also simulated on the sagittal 3D MRI volume by sub-sampling k_{y} with a factor of 4 according to embodiments of the present invention. Various SNAPPI reconstruction were simulated in the 3D k-space and the hybrid space with separable or non-separable SNAPPI kernels (interpolation nets), which are referred to as separable SNAPPI and non-separable SNAPPI, according to embodiments of the present invention.

The following PPI reconstruction simulations were conducted according to embodiments of the present invention:
A) 1DPPI: PPI along k_{y} direction with an AF of 4, data reconstruction with a k_{y}×kₓ=4×6 2D kernel (4×6 neighbors from each component coil) in the hybrid space. For each image slice, 30 central k-space reference lines were used for estimating SNAPPI reconstruction coefficients;
B) 2DPPI-sep-k: PPI along k_{z} and k_{y} using the 2D PPI sampling paradigm as shown in FIG. 2A, separable SNAPPI reconstruction with a k_{z}×k_{y}×kₓ=4×4×3 3D kernel along k_{y} and k_{z} separately in the 3D k-space. 24×24×100 full density sampled central k-space reference data were used for estimating the reconstruction coefficients;
C) 2DPPI-sep-h: The same 2D PPI data as in (B) but reconstruction in the hybrid space with a k_{z}×k_{y}=4×4 2D kernel along k_{y} and k_{z} separately. For each k_{z}-k_{y} plane, 50×60 full density sampled central k-space reference data were used for estimating the reconstruction coefficients;
D) 2DPPI-nonSep-k: The same 2D PPI data as in (B) but using non-separable SNAPPI reconstruction in the 3D k-space with a k_{z}×k_{y}×kₓ=4×4×3 3D kernel for each independently labeled missing point using the label system. 12×12×100 full density sampled central k-space reference data were used for estimating the reconstruction coefficients;
E) 2DPPI-nonSep-h: Different from (D) only by reconstruction in the hybrid space using a k_{z}×k_{y}=4×4 2D kernel for each independently labeled missing point using the label system. For each k_{z}-k_{y} plane, 50×60 full density sampled central k-space reference data were used for estimating the reconstruction coefficients;
F) CAIPIRINHA-k: 2D PPI using the CAIPIRINHA sampling paradigm as shown in FIG. 2B, data reconstruction in 3D k-space with a 3D kernel defined by a cylinder as shown in FIG. 2B for each independently labeled missing point using the label system. 12×12×100 full density sampled central k-space reference data were used for estimating the reconstruction coefficients; and
G) CAIPIRINHA-h: Different from (F) by reconstruction in the hybrid space using a 2D kernel defined by a cylinder as shown in FIG. 2B for each independently labeled missing point using the label system. For each k_{z}-k_{y} plane, 50×60 full density sampled central k-space reference data were used for estimating the reconstruction coefficients.

Simulations with an embodiment of the present invention on 2DPPI-nonSep-k/h and CAIPIRINHA-k/h were also performed on axial 3D MRI data (with PE along y and z) to evaluate the sampling scheme for aliasing control when one PE direction does not have enough sensitivity variation to allow PPI.

### In-vivo 2D PPI Data Reconstruction

The in-vivo 2D PPI data were reconstructed using 2DPPI-sep-k, 2DPPI-nonSep-k, and 2DPPI-nonSep-h as stated above, except that 2DPPI-nonSep-k used 12×16×100 reference data.

To quantify the reconstruction performance of each method, the RRMS between the simulated PPI images and the reference images were calculated for different reconstruction approaches by:

$$RRMS = \sqrt{\frac{{\sum }_{i = 1}^{M} {‖ {I}_{i}^{reference} \vert - \vert {I}_{i}^{recon} ‖}^{2}}{{\sum }_{i = 1}^{M} {‖ {I}_{i}^{reference} ‖}^{2}}}$$

where M is the number of voxels, r^{reference} is the reference image, and i^{recon} is the reconstructed image.

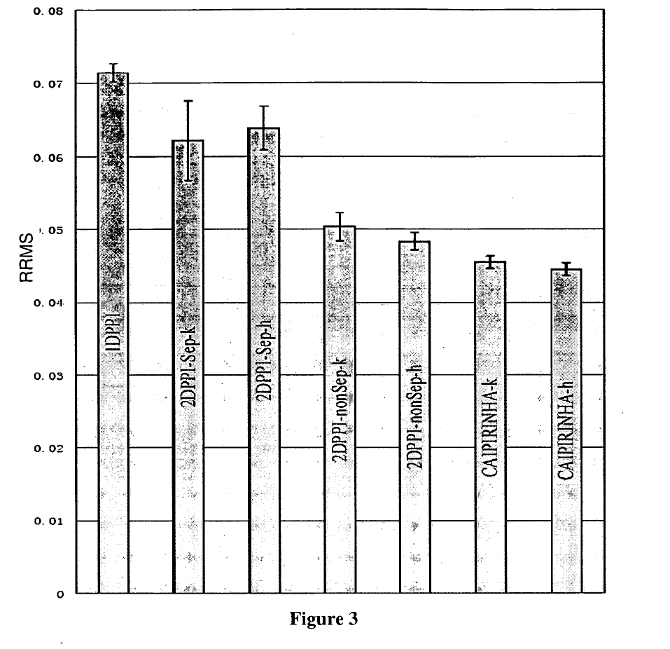

FIG. 3 shows a histogram of the RRMS performance of different SNAPPI reconstructions in the 2D PPI simulations using 5 subjects' sagittal full-FOV scan with PE along y and x according to embodiments of the present invention. All 2D SNAPPI reconstruction methods yielded significantly (P<0.001) reduced RRMS than 1D SNAPPI. Nonseparable 2D SNAPPI reconstruction (2DPPI-nonSep-k and 2DPPI-nonSep-h) outperformed separable SNAPPI reconstruction (2DPPI-Sep-k, 2DPPI-Sep-h) (P<0.001), and 2D SNAPPI with CAIPIRINHA (CAIPIRINHA-k and CAIPIRINHA-h) outperformed 2D SNAPPI with regular 2D PPI sampling paradigm (2DPPI-nonSep-k and 2DPPI-nonSep-h). No significant improvement was found by performing either separable or nonseparable SNAPPI with or without CAIPIRINHA reconstruction in the hybrid space (2DPPI-Sep-h, 2DPPI-nonSep-h and CAIPIRINHA-h) than in the 3D k-space (2DPPI-Sep-k, 2DPPI-nonSep-k and CAIPIRINHA-k).

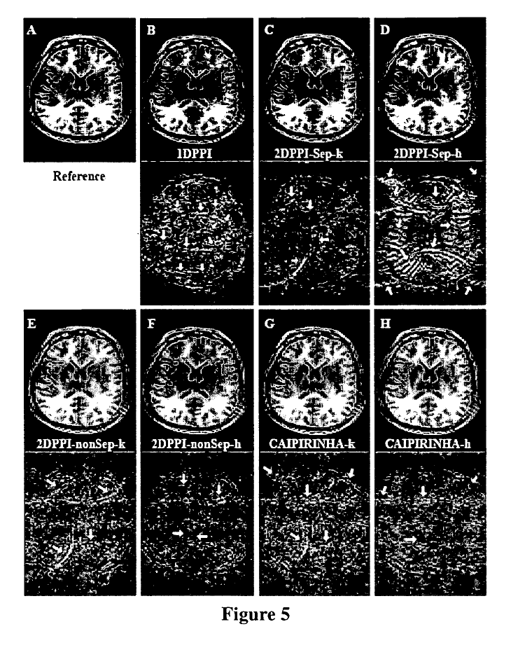

FIG. 5 shows an axial slice of a reference image and the simulated 1D and 2D PPI images reconstructed by various SNAPPI reconstruction strategies using a representative subject's 3D fully sampled sagittal MRI data according to embodiments of the present invention. Section A of FIG. 5 is the reference, and Sections B-H of FIG. 5 are images reconstructed by 1DPPI, 2DPPI-Sep-k, 2DPPI-Sep-h, 2DPPI-nonSep-k, 2DPPI-nonSep-h, CAIPIRINHA-k and CAIPIRINHA-h, respectively. Below each reconstructed image is the difference image (from the reference) displayed using the same gray scale window. All reconstructed images present no perceptible aliasing artifacts, while yielding different noise patterns as shown in the difference images. Consistent with FIG. 3, 1DPPI (Section B of FIG. 5), 2DPPI-Sep-k (Section C of FIG. 5), and 2DPPI-Sep-h (Section D of FIG. 5) yielded higher residual reconstruction errors than other methods. Except the different artifacts pointed to by arrows, there are no other obvious differences between the difference maps of 2DPPI-nonSep-k (Section E of FIG. 5), 2DPPI-nonSep-h (Section F of FIG. 5), CAIPIRINHA-k (Section G of FIG. 5) and CAIPIRINHA-h (Section H of FIG. 5).

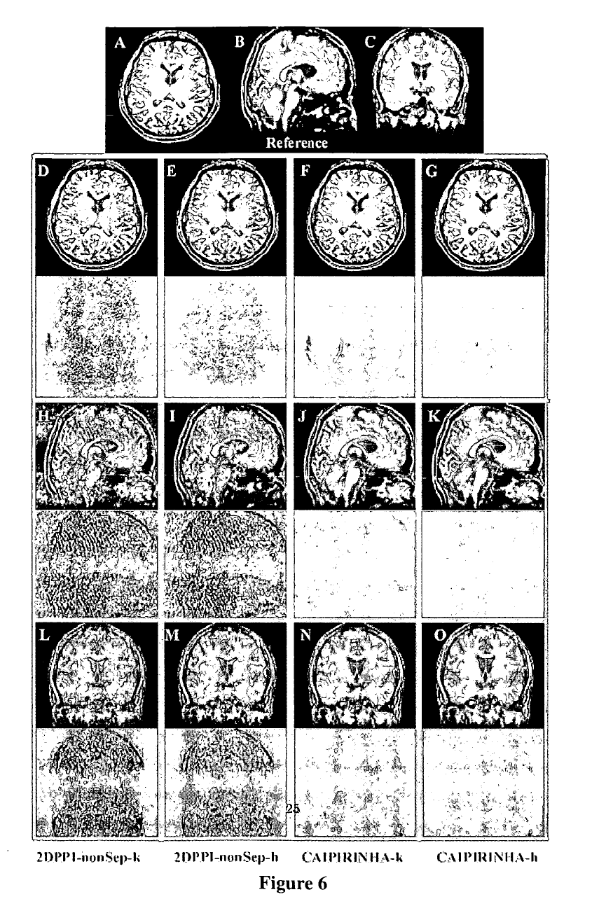

FIG. 6 shows a reference image and the simulated two dimensional PPI images using the full FOV three dimensional axial acquired MRI volume data with phase encoding along y and z according to an embodiment of the present invention. Sections A-C of FIG. 6 are the three views of the reference image. Each column represents a different reconstruction approach as noted by the name underneath. The difference images are also shown right below the corresponding reconstructed images. Different from the simulation results using the sagittal 3D MRI data, significant reconstruction quality improvement was found in the reconstructed PPI images using CAIFIRINHA sampling paradigm (Sections F, G, J, K, N, and O of FIG. 6) than those using regular 2D PPI sampling (Sections D, E, H, I, L, and M of FIG. 6), especially along the z direction, which does not have much coil sensitivity variation for an effective PPI reconstruction for the product receiver array coil used. Only slight differences were found between the images reconstructed in the hybrid space (Sections E, G, I, K, M, and O of FIG. 6) and those reconstructed in the 3D k-space (Sections D, F, H, J, L, and N of FIG. 6).

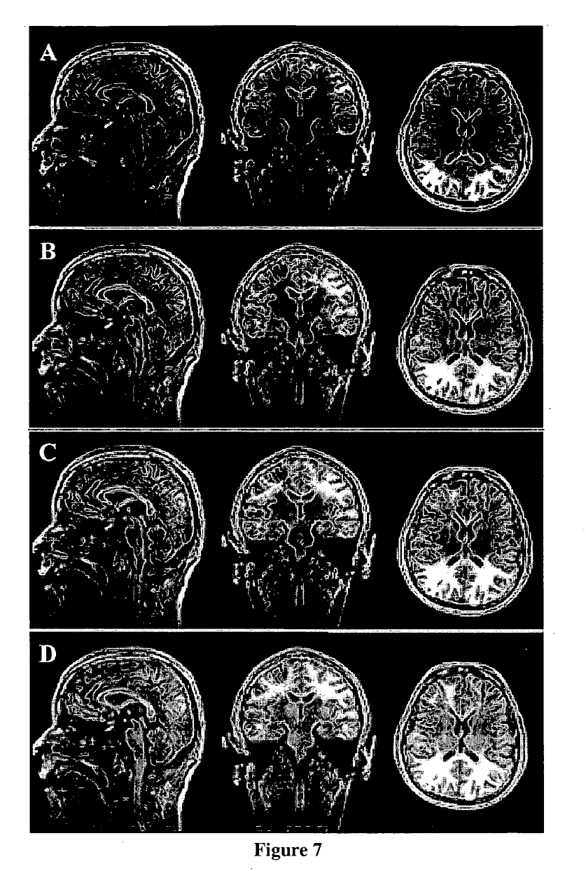

FIG. 7 shows three slices from the sagittal, coronal, and axial views of in-vivo two dimensional PPI images according to an embodiment of the present invention. Both 2DPPI-nonSep-k (Section C of FIG. 7) and 2DPPI-nonSep-h (Section D of FIG. 7) yielded comparable image quality to the reference image (Section A of FIG. 7).

What is claimed is:

1. A method comprising:
identifying a missing data point from one receiver coil of a plurality of receiver coils, wherein said missing data point is not acquired due to partially parallel imaging;
forming an interpolation net having weights comprising said missing data point and acquired data points from said plurality of receiver coils, wherein said acquired data points surround said missing data point;
estimating said weights of said interpolation net using additionally acquired data points surrounding said missing data point; and
reconstructing said missing data point using said weights of said interpolation net.

2. The method of claim 1, wherein said partially parallel imaging has an acceleration factor between 2 and 6.

3. The method of claim 1, wherein said missing data point is a missing k-space data point.

4. The method of claim 1, wherein said missing data point is a missing hybrid space data point.

5. The method of claim 1, wherein said reconstruction is performed along phase encoding direction separately.

6. The method of claim 1, wherein said reconstruction is performed along phase encoding direction together.

7. The method of claim 1, wherein said reconstruction is performed two dimensionally.

8. The method of claim 1, wherein said reconstruction is performed three dimensionally.

9. The method of claim 1, wherein said partially parallel imaging is performed in one dimension.

10. The method of claim 1, wherein said partially parallel imaging is performed in two dimensions.

11. The method of claim 1, wherein said partially parallel imaging is controlled aliasing in parallel imaging results in higher acceleration.

12. A device comprising:
a processor for identifying a missing data point from one receiver coil of a plurality of receiver coils, wherein said missing data point is not acquired due to partially parallel imaging;
the processor for forming an interpolation net having weights comprising said missing data point and acquired data points from said plurality of receiver coils, wherein said acquired data points surround said missing data point;
the processor for estimating said weights of said interpolation net using additionally acquired data points surrounding said missing data point; and
the processor for reconstructing said missing data point using said weights of said interpolation net.

13. The device of claim 12, wherein said partially parallel imaging has an acceleration factor between 2 and 6.

14. The device of claim 12, wherein said missing data point is a missing k-space data point.

15. The device of claim 12, wherein said missing data point is a missing hybrid space data point.

16. The device of claim 12, wherein said reconstruction is performed along phase encoding direction separately.

17. The device of claim 12, wherein said reconstruction is performed along phase encoding direction together.

18. The device of claim 12, wherein said reconstruction is performed two dimensionally.

19. The device of claim 12, wherein said reconstruction is performed three dimensionally.

20. The device of claim 12, wherein said partially parallel imaging is performed in one dimension.

21. The device of claim 12, wherein said partially parallel imaging is performed in two dimensions.

22. The device of claim 12, wherein said partially parallel imaging is controlled aliasing in parallel imaging results in higher acceleration.

23. A processor-readable storage medium having stored thereon instruction that when executed by a processor, result in at least:
identifying a missing data point from one receiver coil of a plurality of receiver coils, wherein said missing data point is not acquired due to partially parallel imaging;
forming an interpolation net having weights comprising said missing data point and acquired data points from said plurality of receiver coils, wherein said acquired data points surround said missing data point;
estimating said weights of said interpolation net using additionally acquired data points surrounding said missing data point; and
reconstructing said missing data point using said weights of said interpolation net.

24. The processor-readable storage medium of claim 23, wherein said partially parallel imaging has an acceleration factor between 2 and 6.

25. The processor-readable storage medium of claim 23, wherein said missing data point is a missing k-space data point.

26. The processor-readable storage medium of claim 23, wherein said missing data point is a missing hybrid space data point.

27. The processor-readable storage medium of claim 23, wherein said reconstruction is performed along phase encoding direction separately.

28. The processor-readable storage medium of claim 23, wherein said reconstruction is performed along phase encoding direction together.

29. The processor-readable storage medium of claim 23, wherein said reconstruction is performed two dimensionally.

30. The processor-readable storage medium of claim 23, wherein said reconstruction is performed three dimensionally.

31. The processor-readable storage medium of claim 23, wherein said partially parallel imaging is performed in one dimension.

32. The processor-readable storage medium of claim 23, wherein said partially parallel imaging is performed in two dimensions.

33. The processor-readable storage medium of claim 23, wherein said partially parallel imaging is controlled aliasing in parallel imaging results in higher acceleration.
